(19) United States
(12) Patent Application Publication
(10) Pub. No.: US 2021/0333615 A1
(43) Pub. Date: Oct. 28, 2021

(54) LIQUID CRYSTAL DISPLAY PANEL AND PREPARATION METHOD THEREOF

(71) Applicant: Shenzhen China Star Optoelectronics Semiconductor Display Technology Co., Ltd., Shenzhen (CN)

(72) Inventors: Yanhong MENG, Shenzhen (CN); Zhixiong JIANG, Shenzhen (CN)

(73) Assignee: Shenzhen China Star Optoelectronics Semiconductor Display Technology Co., Ltd., Shenzhen (CN)

(21) Appl. No.: 16/620,512

(22) PCT Filed: Nov. 5, 2019
(86) PCT No.: PCT/CN2019/115636

§ 371 Date: Dec. 8, 2019

(30) Foreign Application Priority Data
Oct. 14, 2019 (CN) 201910972115.X

(51) Int. Cl. G02F 1/1333; G02F 1/1368; G02F 1/1362; G02F 1/1335

(52) U.S. Cl. CPC G02F 1/133397; G02F 1/1368; G02F 1/136227; G02F 1/133512; G02F 1/133357; G02F 1/136222

(57) ABSTRACT

A liquid crystal display panel and a preparation method thereof, the liquid crystal display panel includes: a first substrate including an active display area and an inactive display area; a second substrate disposed opposite to the first substrate; a thin film transistor layer including a gate electrode layer, a gate insulating layer, an active layer, and a source and drain layer; a first passivation layer; a color photoresist layer; a planarization layer; a pixel electrode layer; a liquid crystal layer; and a second passivation layer disposed between the planarization layer and the liquid crystal layer of the active display area.

### FIELD OF INVENTION

The present invention relates to the field of display technology, and in particular, to a liquid crystal display panel and a method of preparing the same.

### BACKGROUND OF INVENTION

Liquid crystal display panels are widely used in various electronic products, for example, computer devices and mobile phones with display screens. The liquid crystal display panel mainly includes an array substrate, a color filter substrate, and a liquid crystal layer disposed between the array substrate and the color filter substrate. A polymer film on array (PFA) material is widely used in preparation of a planarization layer in the liquid crystal display panel. The material has advantages of low dielectric property, good leveling property, and gas permeability. Since the PFA material has a film thickness greater than that of conventional silicon nitride material, it can effectively reduce parasitic capacitance of a product. In addition, the water-oxygen permeability of the PFA material is better than that of the silicon nitride material, which facilitates discharge of air in the substrate before a cell forming, and can reduce the risk of having bubbles after the cell forming. Moreover, compared with the conventional silicon nitride material, adoption of the PFA material simplifies the process, as it can be patterned by exposure without requiring dry etching and stripping procedures.

### Technical Problem

The PFA material has the above-mentioned advantages. However, the PFA material has a high concentration of ions, which are easy to diffuse into the liquid crystal layer, and thereby causing a residual direct current, resulting in a problem of image sticking (IS).

### SUMMARY OF INVENTION

In order to solve the problems that use of the PFA material in an array substrate process causing a residual direct current, and resulting in image sticking. The present invention provides a liquid crystal display panel, including: a first substrate including an active display area and an inactive display area; a second substrate disposed opposite to the first substrate; a liquid crystal layer disposed between the first substrate and the second substrate; a thin film transistor layer disposed on the first substrate, including a gate electrode layer, a gate insulating layer, an active layer, and a source and drain layer; a first passivation layer disposed on the thin film transistor layer; a color photoresist layer disposed on the first passivation layer; a planarization layer disposed on the color photoresist layer; a pixel electrode layer disposed on the planarization layer and connected to the source and drain layer through a via hole; and a second passivation layer disposed between the planarization layer and the liquid crystal layer and configured to isolate the planarization layer and the liquid crystal layer.

Preferably, the second passivation layer is disposed between the planarization layer and the liquid crystal layer of the active display area.

Preferably, the planarization layer is composed of an organic polymer material.

Preferably, the liquid crystal display panel further includes a light shielding layer disposed on the second substrate.

Preferably, the liquid crystal display panel further includes a common electrode layer disposed on the second substrate and the light shielding layer.

Preferably, the color photoresist layer includes a red sub-pixel unit, a green sub-pixel unit, and a blue sub-pixel unit.

Preferably, the first passivation layer is composed of silicon oxide or silicon nitride.

Preferably, the second passivation layer is composed of silicon oxide or silicon nitride.

The present invention provides another liquid crystal display panel, including: a first substrate including an active display area and an inactive display area; a second substrate disposed opposite to the first substrate; a liquid crystal layer disposed between the first substrate and the second substrate; a thin film transistor layer disposed on the first substrate, including a gate electrode layer, a gate insulating layer, an active layer, and a source and drain layer; a first passivation layer disposed on the thin film transistor layer; a color photoresist layer disposed on the first passivation layer; a planarization layer composed of an organic polymer material disposed on the color photoresist layer; a pixel electrode layer disposed on the planarization layer and connected to the source and drain layer through via holes; and a second passivation layer disposed between the planarization layer and the liquid crystal layer of the active display area and configured to isolate the planarization layer and the liquid crystal layer.

Preferably, the liquid crystal display panel further includes a light shielding layer disposed on the second substrate.

Preferably, the liquid crystal display panel further includes a common electrode layer disposed on the second substrate and the light shielding layer.

Preferably, the color photoresist layer includes a red sub-pixel unit, a green sub-pixel unit, and a blue sub-pixel unit.

Preferably, the first passivation layer is composed of silicon oxide or silicon nitride.

Preferably, the second passivation layer is composed of silicon oxide or silicon nitride.

The invention further provides a method for preparing a liquid crystal display panel, including: providing a first substrate including an active display area and an inactive display area; forming a thin film transistor layer, a first passivation layer, a color photoresist layer, a planarization layer, and a pixel electrode layer on the first substrate; providing a mask including an opening area corresponding to the active display area and a shielding area corresponding to the inactive display area; forming a second passivation layer on the active display area of the first substrate with the mask, the second passivation layer is preferably composed of silicon oxide or silicon nitride; forming a liquid crystal layer on the first substrate; providing a second substrate; forming a light shielding layer and a common electrode layer on the second substrate; and bonding the first substrate and the second substrate.

### Beneficial Effect

In the liquid crystal display panel of the embodiment of the present invention, the second passivation layer film composed of silicon dioxide (SiO₂) or silicon nitride (SiNₓ) is deposited between the planarization layer and the liquid crystal layer. This prevents ions in the planarization layer, which consist of the organic polymer material, from diffusing into the liquid crystal layer, thereby preventing problems of residual direct current and image sticking.

In addition, a conventional process forms the second passivation layer before the preparation of the pixel electrode layer, which requires a mask and processes of exposure, dry etching, and photoresist stripping to achieve the connection of the pixel electrode layer and the thin film transistor layer. Compared to the conventional process, the present invention forms the second passivation layer after the preparation of the pixel electrode layer, which achieves the connection of the pixel electrode layer and the thin film transistor layer and saves the cost of a mask and reduces the working time.

Since some metal pads on the periphery of the first substrate need to be electrically connected to the second substrate for signal transmission, if the second layer is deposited after the pixel electrode layer is patterned, the periphery will be completely insulated and the signal cannot be transmitted to the second substrate. Therefore, in order to realize the transmission of the peripheral signal, the present invention adopts a special mask to shield when depositing the second layer. Consequently, the active display area of the first substrate is covered by the second passivation layer, and the periphery (i.e. the inactive display area) is not covered by the second passivation layer. This can prevent ions from diffusing into the liquid crystal layer, and can also ensure signal transmission between the peripheral metal pad and the second substrate.

### DESCRIPTION OF DRAWINGS

In order to more clearly illustrate the technical solutions in the embodiments of the present invention, the following figures described in the embodiments will be briefly introduced. It is obvious that the drawings described below are merely some embodiments of the present invention, and other drawings can also be obtained by a person of ordinary skill in the art based on these drawings without any creative effort.

FIG. 1 is a side cross-sectional view of a liquid crystal display panel of an embodiment of the present invention.

FIG. 2 is a flow chart of preparing a liquid crystal display panel according to an embodiment of the present invention.

FIG. 3 is a top plan view of a first substrate of an embodiment of the present invention.

FIG. 4 is a schematic view of a mask for preparing a second passivation layer of a first substrate according to an embodiment of the present invention.

### DETAILED DESCRIPTION OF PREFERRED EMBODIMENTS

The technical solutions in the embodiments of the present invention will be clearly and completely described in the following with reference to the accompanying drawings. It is obvious that the described embodiments are only a part of the embodiments of the invention, and not all of the embodiments. All other embodiments obtained by a person skilled in the art based on the embodiments of the present invention without creative efforts are within the scope of the present application.

The following description of the embodiments is a reference to the drawings of the accompanying drawings to illustrate specific embodiments of the invention. Directional terminology mentioned in the present invention, such as “upper”, “lower”, “front”, “back”, “left”, “right”, “inside”, “outside”, “side”, etc., are merely references to the direction of the drawings. Therefore, the directional terminology used is for the purpose of illustration and understanding of the invention rather than limiting the invention.

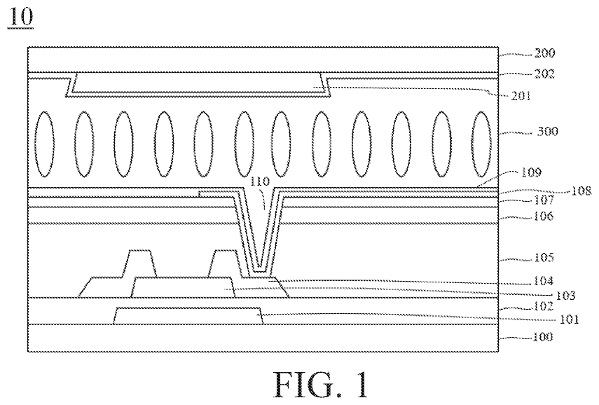

Shown in FIG. 1 is a liquid crystal display panel 10 of an embodiment of the present invention, including:

a first substrate 100; a second substrate 200 disposed opposite to the first substrate 100, the first substrate 100 and the second substrate 200 are preferably glass substrates; a liquid crystal layer 300 disposed between the first substrate 100 and the second substrate 200; a thin film transistor layer disposed on the first substrate 100, including a gate electrode layer 101, a gate insulating layer 102, an active layer 103, and a source and drain layer 104; a first passivation layer 105 disposed on the thin film transistor layer; a color photoresist layer 106, including a red sub-pixel unit, a green sub-pixel unit, and a blue sub-pixel unit, disposed on the first passivation layer 105; a planarization layer 107 disposed on the color photoresist layer 106; a pixel electrode layer 108 composed of indium tin oxide disposed on the planarization layer 107 and connected to the source and drain layer 104 through a via hole 110; and a second passivation layer 109 disposed between the planarization layer 107 and the liquid crystal layer 300 and configured to isolate the planarization layer 107 and the liquid crystal layer 300.

The liquid crystal display panel 10 of an embodiment of the present invention further includes a light shielding layer 201 disposed between the second substrate 200 and the liquid crystal layer 300.

The liquid crystal display panel 10 of the embodiment of the present invention further includes a common electrode layer 202 composed of indium tin oxide disposed between the second substrate 200 and the liquid crystal layer 300.

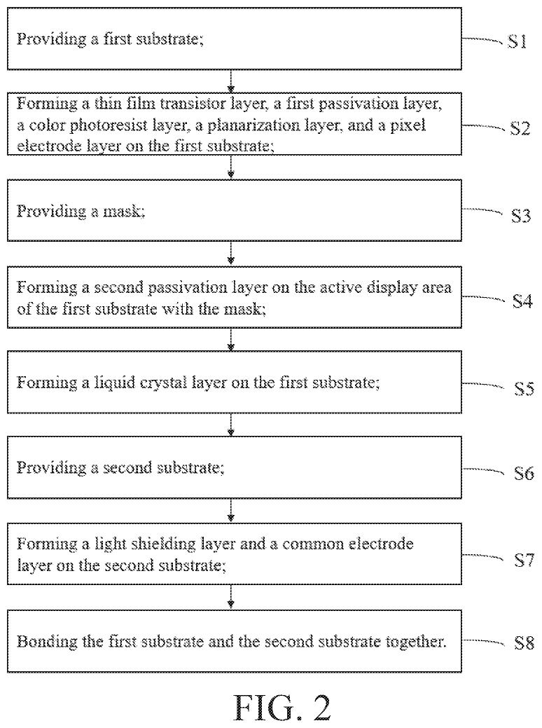

Shown in FIG. 2 is a flow chart of preparing a liquid crystal display panel according to an embodiment of the present invention, including:

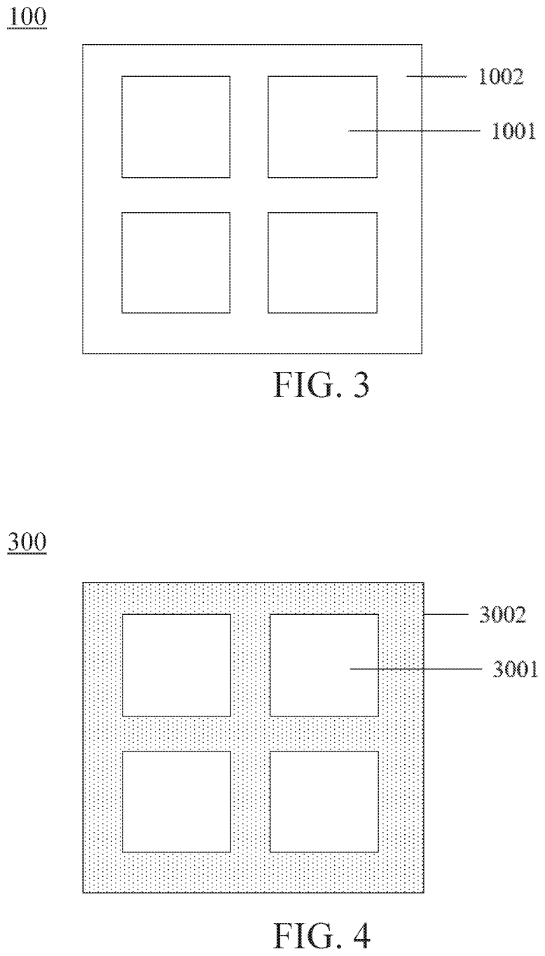

S1, providing a first substrate 100, preferably a glass substrate, the first substrate 100, as shown in FIG. 3, including an active display area 1001 and an inactive display area 1002;

S2, then, starting an array process on the first substrate 100: after cleaning the first substrate 100, performing processes of thin film deposition, photoresist coating, exposure, development, etching, stripping, and the like on the first substrate 100; repeating the above steps several times to complete the preparation of the thin film transistor layer; following, depositing silicon dioxide (SiO₂) on the thin film transistor layer to complete the preparation of the first passivation layer. After completing the preparation of the first passivation layer, a color photoresist layer including a red color resist unit, a green color resist unit, and a blue color resist unit is prepared by inkjet printing; next, preparing a planarization layer on the color photoresist layer by applying an organic polymer solution and baking; following, preparing a pixel electrode layer by processes such as thin film deposition, photoresist coating, exposure, development, etching, stripping and the like.

S3, next, providing a mask 300 as shown in FIG. 4. The mask 300 includes an opening area 3001 corresponding to the active display area 1001 of the first substrate 100 and a shielding area 3002 corresponding to the inactive display area 1002 of the first substrate 100;

S4, using the mask 300 to prepare a second passivation layer on the active display area 1001 of the first substrate 100 by depositing silicon dioxide or silicon nitride;

S5, then, performing processes of alignment film printing, alignment film alignment, sealant coating, and liquid crystal injection on the first substrate 100 to complete preparation of the liquid crystal layer;

S6, providing a second substrate 200, preferably a glass substrate, and performing a color filter process on the second substrate 200;

S7, preparing a light shielding layer on the second substrate 200 by processes of applying a light shielding adhesive, exposure, development, and the like; then, the preparation of a common electrode layer is completed by processes such as thin film deposition, photoresist coating, exposure, development, etching, stripping, and the like; and

S8, finally, bonding the first substrate 100 and the second substrate 200 together to complete the preparation of the liquid crystal display panel 10 of the embodiment.

The description of the above exemplary embodiments is only for the purpose of understanding the invention. It is to be understood that the present invention is not limited to the disclosed exemplary embodiments. It is obvious to those skilled in the art that the above exemplary embodiments may be modified without departing from the scope and spirit of the present invention.

What is claimed is:

1. A liquid crystal display panel, comprising:
a first substrate comprising an active display area and an inactive display area;
a second substrate disposed opposite to the first substrate;
a liquid crystal layer disposed between the first substrate and the second substrate;
a thin film transistor layer disposed on the first substrate and comprising a gate electrode layer, a gate insulating layer, an active layer, and a source and drain layer;
a first passivation layer disposed on the thin film transistor layer;
a color photoresist layer disposed on the first passivation layer;
a planarization layer disposed on the color photoresist layer;
a pixel electrode layer disposed on the planarization layer and connected to the source and drain layer through a via hole; and
a second passivation layer disposed between the planarization layer and the liquid crystal layer and configured to isolate the planarization layer and the liquid crystal layer.

2. The liquid crystal display panel of claim 1, wherein the second passivation layer is disposed between the planarization layer and the liquid crystal layer of the active display area.

3. The liquid crystal display panel of claim 1, wherein the planarization layer is made of an organic polymer material.

4. The liquid crystal display panel of claim 1, further comprising a light shielding layer disposed on the second substrate.

5. The liquid crystal display panel of claim 1, further comprising a common electrode layer disposed on the second substrate and the light shielding layer.

6. The liquid crystal display panel of claim 1, wherein the color photoresist layer comprises a red sub-pixel unit, a green sub-pixel unit, and a blue sub-pixel unit.

7. The liquid crystal display panel of claim 1, wherein the first passivation layer is composed of silicon oxide or silicon nitride.

8. The liquid crystal display panel of claim 1, wherein the second passivation layer is composed of silicon oxide or silicon nitride.

9. A method for preparing a liquid crystal display panel, comprising:
providing a first substrate comprising an active display area and an inactive display area;
forming a thin film transistor layer, a first passivation layer, a color photoresist layer, a planarization layer, and a pixel electrode layer on the first substrate;
providing a mask comprising an opening area corresponding to the active display area and a shielding area corresponding to the inactive display area;
forming a second passivation layer on the active display area of the first substrate with the mask;
forming a liquid crystal layer on the first substrate;
providing a second substrate;
forming a light shielding layer and a common electrode layer on the second substrate; and
bonding the first substrate and the second substrate;
wherein the second passivation layer is disposed between the planarization layer and the liquid crystal layer and configured to isolate the planarization layer and the liquid crystal layer.

10. The method of claim 9, wherein the second passivation layer is composed of silicon oxide or silicon nitride.

11. A liquid crystal display panel, comprising:
a first substrate comprising an active display area and an inactive display area;
a second substrate disposed opposite to the first substrate;
a liquid crystal layer disposed between the first substrate and the second substrate;
a thin film transistor layer disposed on the first substrate, and comprising a gate electrode layer, a gate insulating layer, an active layer, and a source and drain layer;
a first passivation layer disposed on the thin film transistor layer;
a color photoresist layer disposed on the first passivation layer;
a planarization layer disposed on the color photoresist layer, wherein the planarization layer is made of an organic polymer material;
a pixel electrode layer disposed on the planarization layer and connected to the source and drain layer through a via hole; and
a second passivation layer disposed between the planarization layer and the liquid crystal layer of the active display area and configured to isolate the planarization layer and the liquid crystal layer.

12. The liquid crystal display panel of claim 11, further comprising a light shielding layer disposed on the second substrate.

13. The liquid crystal display panel of claim 11, further comprising a common electrode layer disposed on the second substrate and the light shielding layer.

14. The liquid crystal display panel of claim 11, wherein the color photoresist layer comprises a red sub-pixel unit, a green sub-pixel unit, and a blue sub-pixel unit.

15. The liquid crystal display panel of claim 11, wherein the first passivation layer is composed of silicon oxide or silicon nitride.

16. The liquid crystal display panel of claim 11, wherein the second passivation layer is composed of silicon oxide or silicon nitride.
